(19) United States
(12) Patent Application Publication
(10) Pub. No.: US 2025/0388193 A1
(43) Pub. Date: Dec. 25, 2025

(54) MECHANICAL LOCKING MECHANISM WITH SWITCHING ELEMENT FOR SECURE FIXING IN AN UNLOCKED POSITION

(71) Applicant: Robert Bosch GmbH, Stuttgart (DE)

(72) Inventor: Frank Baehrle-Miller, Schoenaich (DE)

(21) Appl. No.: 19/202,722

(22) Filed: May 8, 2025

(30) Foreign Application Priority Data
May 17, 2024 (DE) 10 2024 204 602.7

(51) Int. Cl. B60T 1/00; B60T 13/74; F16D 63/00; F16D 121/20; F16D 127/06

(52) U.S. Cl. CPC B60T 1/005; B60T 13/746; F16D 63/006; F16D 2121/20; F16D 2127/06

(57) ABSTRACT

A locking mechanism for an electromechanical brake for locking an actuating direction of an electromechanical brake. The locking mechanism includes a ratchet wheel and a pawl configured to block a direction of rotation of the ratchet wheel in a locked state of the locking mechanism and release the rotation of the ratchet wheel in an unlocked state. A switching element, in a rest state of the switching element, fixes the pawl in the unlocked state of the locking mechanism, and an actuator is provided. The switching element is transferred using a rotational and/or a translational displacement from the rest state into a first switching state, in which a movement of the pawl is released. The switching element is functionally arranged between the actuator and the pawl, so that the switching element can be switched using the actuator and the actuator acts on the pawl using the switching element.

### FIELD

The present invention relates to a locking mechanism for use in an electromechanical brake, in particular a locking mechanism which locks an actuating direction of an electromechanical brake.

### BACKGROUND INFORMATION

In order to implement a parking brake function in electromechanical brakes, various technical solutions are described in the related art. German Patent Application No. DE 10 224 688 A1 describes a method for actuating a parking brake system which is integrated into an electromechanical service brake. In order to apply the parking brake, the brake is actuated by means of its brake actuator when the vehicle is stationary, and is locked in the actuated position by means of a locking mechanism. The locking mechanism includes a pawl and a ratchet wheel which is connected to the brake actuator. For locking, the movement of the pawl is released by means of a latch and then the pawl is brought into engagement with the ratchet wheel. The unlocking of the pawl and the actuation of the pawl are each carried out by using an electromagnet. The latch ensures that the pawl does not accidentally engage the ratchet wheel, as could be caused for example by vibrations during driving. The disadvantage of this solution is the increased complexity, since two actuators are required to actuate the locking mechanism, which entails increased outlay for cabling, control technology and installation space.

German Patent Application No. DE 10 234 848 describes a comparable mechanism for fixing an electromechanical service brake. Furthermore, it is generally conventional to use a rotationally movable pawl to lock a ratchet wheel, as can also be used in an electromechanical service brake, in order to form a locking mechanism as a parking brake. In order to apply the necessary locking forces, the pawl must be made sufficiently strong and durable, which entails greater weight. The pawl can be held in the unlocked position by a spring element and moved into the locked position by an actuator against this spring. The disadvantage here is that the pawl can be moved into the locked position by reaction forces resulting from accelerations, even without activation of the actuator against the spring force. To prevent this unintentional locking, the spring element can be designed to be sufficiently strong, which however means that the actuator must correspondingly apply more force for the actuation. The disadvantage of this is that a more powerful and therefore larger actuator must be used, which entails a greater use of material and a greater expenditure of energy for actuation.

An object of the present invention is to provide a locking mechanism for an electromechanical service brake which overcomes the aforementioned disadvantages of the related art.

### SUMMARY

A locking mechanism according to the present invention comprising a switching element according to the present invention, and an electromechanical brake, and a method for operating a locking mechanism, have the advantage that a single actuator is provided for actuating the pawl and for unlocking the pawl. This actuator is advantageously of low power and can therefore be made small. This saves installation space and costs. Furthermore, the controlling is simplified compared to the related art, because only one actuator needs to be controlled.

According to an example embodiment of the present invention, the locking mechanism for an electromechanical brake, in particular for locking an actuating direction of an electromechanical brake, preferably for use in a motor vehicle, in particular in a passenger car, comprises a ratchet wheel and a pawl. The pawl is designed to block a direction of rotation of the ratchet wheel in a locked state of the locking mechanism and to release the rotation of the ratchet wheel in an unlocked state of the locking mechanism. Furthermore, the locking mechanism comprises a switching element which, in a rest state of the switching element, fixes the pawl in the unlocked state of the locking mechanism, and an actuator, in particular a magnetic coil or a linear drive.

According to an example embodiment of the present invention, it is provided that the switching element can be transferred by means of a rotational and/or a translational displacement from the rest state into a first switching state in which a movement of the pawl, preferably a rotation about an axis of rotation, is released. The switching element is functionally arranged between the actuator and the pawl, so that the switching element can be switched by means of the actuator and the actuator also acts on the pawl by means of the switching element. This embodiment ensures, by means of the switching element, that the pawl is securely fixed in the unlocked state of the locking mechanism, even at high accelerations. Unlike in the related art, a spring which has a lower spring constant is therefore sufficient as a restoring means. Consequently, the actuating force of the pawl against the spring force of the return spring is lower, so that a lower-power actuator is sufficient for actuation.

Advantageous further developments of the locking mechanism according to the present invention are disclosed herein.

In order to avoid unnecessary duplication, features disclosed in relation to the device of the present invention should also be considered to be disclosed in relation to the method of the present invention, and vice versa.

In a first preferred example embodiment of the locking mechanism of the present invention, the switching element can be spring-loaded by means of a first spring element towards the rest state of the switching element. The first spring element can be dimensioned such that the switching element remains in the rest state of the switching element during accelerations below a limit value, which is preferably 50 times, more preferably 80 times, particularly preferably 100 times the gravitational acceleration. This advantageously ensures that the switching element is securely fixed in the rest state of the switching element even at high accelerations, such as those that may occur when driving through potholes. Because the switching element is not located in the force path of the locking mechanism, it does not have to withstand high mechanical loads, so that a design with low mechanical load capacity is sufficient. Consequently, the switching element can be dimensioned compactly, which leads to a low mass of the switching element. Due to the low mass of the switching element, a correspondingly low restoring force and thus a low spring constant of the spring element are sufficient to withstand the forces acting on the switching element up to the acceleration limit value mentioned above. Due to this low spring constant, a low actuating force is sufficient to operate the switching element, which is why a small actuator which has low power is sufficient.

In a next preferred example embodiment of the locking mechanism of the present invention, a recess can be formed in the switching element, which recess, in the rest state of the switching element, mechanically interacts with a holding element of the pawl, in particular forms a latching connection and mechanically blocks the movement of the pawl, in particular the rotation about an axis of rotation. Advantageously, the position of the pawl is mechanically fixed in such a way that, for any external load, it is ensured that the pawl is fixed in the unlocked state of the locking mechanism. The design with a recess and a holding element is particularly simple and therefore cost-effective.

In a further preferred example embodiment of the locking mechanism of the present invention, the pawl can be spring-loaded using a second spring element towards the unlocked state of the locking mechanism. The pawl can be transferred from the locked state to the unlocked state of the locking mechanism by means of the second spring element, wherein the second spring element is dimensioned such that the pawl can be transferred from the locked state to the unlocked state of the locking mechanism by means of the spring force of the second spring element in any spatial position of the locking mechanism. By means of the second spring element as a return means for the pawl, it is ensured that the function of the locking mechanism is reliable in every spatial position of a vehicle in which the locking mechanism is installed. A spring element as a return means for the pawl is particularly simple to construct and also cost-effective to manufacture. The embodiment thus advantageously contributes to a cost-effective overall system. Furthermore, a spring element is durable, ensuring a long service life of the entire system.

In a next preferred example embodiment of the locking mechanism of the present invention, the switching element can comprise an actuating means for acting on the pawl, in particular for moving the pawl, preferably for rotating it about an axis of rotation, from the unlocked state into the locked state of the locking mechanism. In the first switching state of the switching element, the actuating means lies against the pawl in a contacting manner, and in a second switching state, the movement of the pawl is released and the pawl is moved, preferably rotated, into the locked state of the locking mechanism by means of force applied via the actuating means. The actuating means can, for example, be designed as a pin protruding from the switching element. The interaction between the switching element and the pawl is thus achieved in a structurally advantageous and simple manner. Furthermore, it is advantageously mechanically ensured that the actuating force of the actuator only acts on the pawl in the switching state of the switching element, when the movement of the pawl is released. The control of the entire locking mechanism is therefore advantageously simple. It is mechanically necessarily ensured that the pawl is only actuated when in the unlocked state.

In a further preferred example embodiment of the locking mechanism of the present invention, the switching element can be designed to be weight-optimized, with the lowest possible mass and/or with an advantageously balanced distribution of the mass. In order to achieve the lowest possible mass, it can be designed as a lightweight component and/or from a material which has the lowest possible density, preferably from an aluminum alloy or a plastics material. Additionally or alternatively, it can be designed to be weight-optimized with regard to achieving an advantageously balanced distribution of the mass. Designing the switching element as a lightweight component results in a low mass of the switching element. A low mass of the switching element allows a low spring constant of the first spring element, which is advantageous because the actuator has to actuate the switching element against this spring force. Additionally or alternatively, a switching element that is balanced relative to an axis of movement of the switching element can have an advantageous effect, because accelerations acting on the switching element from the outside do not result in forces on the switching element for translational and/or rotational displacement of the switching element. The spring force of the first spring element fixes the switching element against these forces and can be designed to be correspondingly weaker for lower forces. A weight-optimized design of the switching element therefore allows the use of an actuator which has the lowest possible power, and consequently is of low cost and compact dimensions.

In a next preferred embodiment of the locking mechanism of the present invention, the switching element can be designed in one piece, in particular monolithically, and can preferably be produced by means of injection molding and/or stamping and/or forming. A one-piece design allows for an advantageously simple and therefore cost-effective production of the switching element. Complex joining processes for production can be dispensed with. For high quantities, as is particularly expected in vehicle construction, the manufacturing processes of injection molding and/or stamping and/or forming are particularly advantageous, as they allow for particularly cost-effective large-series production.

Furthermore, the present invention also comprises an electromechanical brake, preferably having a function as a parking brake, in particular for use in a motor vehicle, preferably in a passenger car, at least comprising a locking mechanism according to the present invention. Such an electromechanical brake has the advantage that it is mechanically particularly simple. By means of the locking mechanism according to the present invention, it is particularly easy to implement a parking brake function in an electromechanical brake. Therefore, the electromechanical brake, as an overall system, is advantageously simple in design, compact, and easy to control.

Furthermore, the present invention also comprises a method for operating, in particular for reversibly locking, a locking mechanism for an electromechanical brake, which in particular locks an actuating direction of the electromechanical brake, preferably for use in a motor vehicle, in particular in a passenger car. According to an example embodiment of the present invention, the method comprises the method steps of:
rotational and/or translational displacement of a switching element against the spring action of a first spring element from a rest state to a first switching state by the action of an actuator,
release of a pawl by the switching element to produce movability of the pawl,
displacement of the pawl against the spring action of a second spring element in order to engage a ratchet wheel, and transfer of the locking mechanism from the unlocked to the locked state.

According to an example embodiment of the present invention, it is provided that the switching element is displaced by the actuator from the first switching state to a second switching state, and in the process acts on the pawl by means of an actuating means, in particular displacing the pawl from the unlocked to the locked state against the spring action of a second spring element, so that the pawl interacts in a locking manner with the ratchet wheel when the second switching state is reached. Advantageously, controlling a single actuator is sufficient to carry out the multi-stage switching sequence. Therefore, the process is easy to apply from a control point of view. There is no need to monitor the switching state of the actuator, because the successive sequences are mechanically fixed. For example, there is no need to monitor the switching state of the switching element in order to prevent the pawl from being actuated while it is still locked by the switching element.

Further advantages, features, and details of the present invention can be found in the following description of preferred example embodiments of the present invention and with reference to the figures.

Features disclosed with respect to the device of the present invention are also to be considered to be disclosed with respect to the method of the present invention, and vice versa.

Identical elements or elements which have the same function are provided with the same reference signs in the figures.

### BRIEF DESCRIPTION OF THE DRAWINGS

FIG. 1 shows a detail of a locking mechanism according to an example embodiment of the present invention in a schematic representation in the unlocked state and in the rest state of the switching element.

FIG. 2 shows a detail of a locking mechanism according to an example embodiment of the present invention in a schematic representation in the unlocked state and in the first switching state of the switching element.

FIG. 3 shows a detail of a locking mechanism according to the present invention in a schematic representation in the locked state and in the second switching state of the switching element.

### DETAILED DESCRIPTION OF EXAMPLE EMBODIMENTS

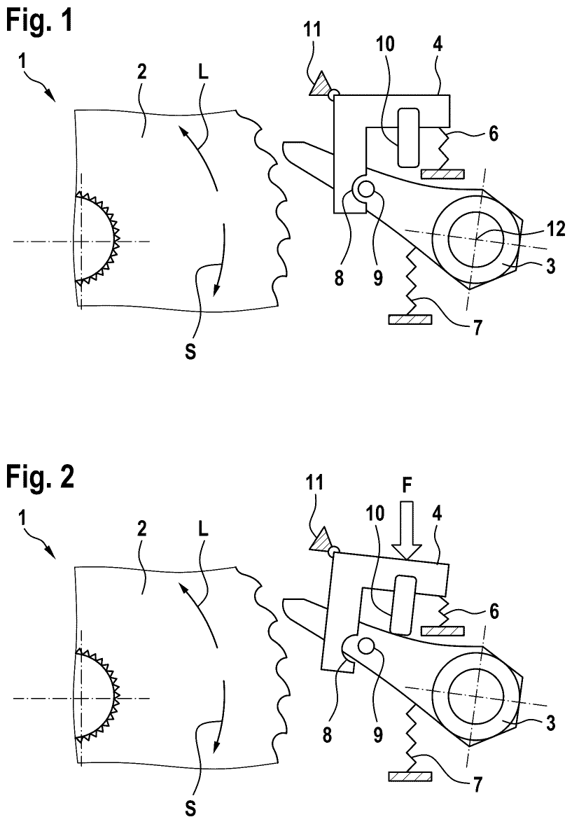

The schematic representation of FIG. 1 shows a detail of a locking mechanism 1 of an electromechanical brake. Here the ratchet wheel 2 can be connected to the actuating device of the electromechanical brake in a rotationally fixed manner. When the electromechanical brake is actuated, the ratchet wheel 2 rotates in the release direction L and, when the electromechanical brake is released, it rotates in the locking direction S. The pawl 3 is rotatably mounted about the pivot joint 12 of the pawl 3. The second spring element 7, which in the illustrated embodiment is designed as a compression spring, loads the pawl 3 towards the unlocked state shown. The switching element 4 is shown in the rest state. It is rotatably mounted about the pivot joint 11 of the switching element and is spring-loaded by the first spring element 6, which in the illustrated embodiment is designed as a compression spring, towards the rest state shown.

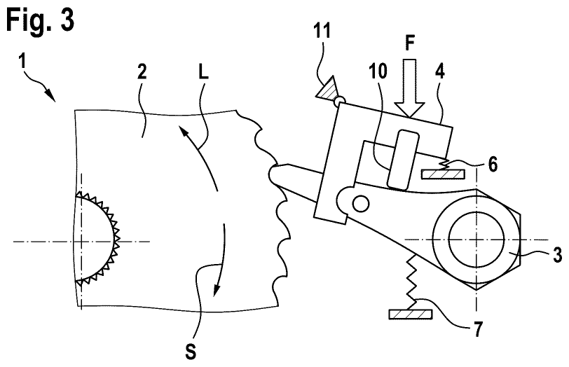

The first spring element 6 holds the switching element 4, i.e. in the rest state shown. In the rest state, a recess 8 of the switching element 4 and the holding element 9 of the pawl 3 form a latching connection with each other, which fixes the pawl 3 in the unlocked position. By means of this latching connection, the pawl 3 is securely held in the unlocked state even at high accelerations. The switching element 4 is a lightweight component made of light metal and has a one-piece construction. The pawl 3 and the pivot joint 12 of the pawl 3 are designed and loadable according to the loads of the particular application. The spring constant of the first spring element 6 is selected such that the switching element 4 remains in the rest state shown even at accelerations of up to 80 times the gravitational acceleration. In the rest state of the switching element 4, the actuating means 10 does not lie against the pawl 3 in a contacting manner. The second spring element 7 is further described with reference to FIGS. 2 and 3.

In order to achieve the first switching state of the switching element 4 shown in FIG. 2, an actuating force F of a suitable actuator, which is not shown, acts on the switching element 4. The switching element 4 is rotated against the spring force of the first spring element 6. The latching connection between the recess 8 and the holding element 9 is released. In the first switching state, the actuating means 10 of the switching element 4 is in contact with the pawl 3. The pawl 3 is still in the unlocked state here and does not engage the ratchet wheel 2. The ratchet wheel 2 can rotate in both directions.

By further applying the actuating force F of the actuator, the state shown in FIG. 3 is reached. For this purpose, the switching element 4 is rotated further against the spring force of the first spring element 6 by the actuator (not shown). The actuating means 10 of the switching element 4 acts on the pawl 3 so that the pawl rotates against the spring action of the second spring element 7. The pawl 3 is in the locking state with the ratchet wheel 2. The locking direction S of the ratchet wheel 2 is blocked by the pawl 3. The release direction L of the ratchet wheel 2 is still enabled. Due to the rotationally fixed connection of the ratchet wheel 2 to the actuating device of the electromechanical brake, the electromechanical brake cannot be released in this state, but can only be further applied. This provides the function of a parking brake.

In order to release the locking mechanism 1 and thus to release the parking brake function of the electromechanical brake, the actuator is actuated further in the direction of the actuating force F, so that the positive connection between the ratchet wheel 2 and the pawl 3 is removed. After this positive connection is released, the actuator is deactivated and switched force-free. By means of the spring force of the first spring element 6 and the second spring element 7, the switching element 4 is rotated in the direction of the initial state and the pawl 3 is rotated away from the ratchet wheel 2 and towards its initial state. The positive connection between the recess 8 and the holding element 9 is established here. The switching element 4 acts on the actuator, which is switched force-free, so that the actuator is pushed into its initial position. In an alternative embodiment, the actuator can also be activated in a controlled manner during release, so that the movement of the switching element 4, the pawl 3 and the actuator into the initial position occurs more slowly, which advantageously reduces the noise generated during release.

1-9. (canceled)

10. A locking mechanism for an electromechanical brake, for locking an actuating direction of an electromechanical brake, the locking mechanism comprising:
a ratchet wheel and a pawl configured to block a direction of rotation of the ratchet wheel in a locked state of the locking mechanism and to release the rotation of the ratchet wheel in an unlocked state of the locking mechanism;
a switching element which, in a rest state of the switching element, fixes the pawl in the unlocked state of the locking mechanism; and
an actuator including a magnetic coil or a linear drive;
wherein the switching element can be transferred via a rotational and/or a translational displacement from the rest state into a first switching state, in which a movement of the pawlis released, the switching element being functionally arranged between the actuator and the pawl, so that the switching element can be switched via the actuator, and the actuator also acts on the pawl via the switching element.

11. The locking mechanism for an electromechanical brake according to claim 10, wherein the switching element is spring-loaded, by a first spring element, towards the rest state of the switching element, the first spring element being dimensioned such that the switching element remains in the rest state of the switching element during accelerations below a limit value.

12. The locking mechanism for an electromechanical brake according to claim 10, wherein a recess is formed in the switching element, the recess, in the rest state of the switching element, mechanically interacting with a holding element of the pawl, forming a latching connection and mechanically blocking the movement of the pawl the movement including a rotation about an axis of rotation.

13. The locking mechanism for an electromechanical brake according to claim 10, wherein the pawl is spring-loaded using a second spring element towards the unlocked state of the locking mechanism, the pawl being transferrable from the locked state into the unlocked state of the locking mechanism via the second spring element, the second spring element being dimensioned such that the pawl can be transferred from the locked state into the unlocked state of the locking mechanism by means via a spring force of the second spring element in any spatial position of the locking mechanism.

14. The locking mechanism for an electromechanical brake according to claim 10, wherein the switching element includes an actuating arrangement configured to act on the pawl for moving the pawl, from the unlocked state into the locked state of the locking mechanism, wherein, in the first switching state of the switching element, the actuating arrangement lies against the pawl in a contacting manner and wherein, in a second switching state, the movement of the pawl is released and the pawl is moved into the locked state of the locking mechanism via a force applied via the actuating arrangement.

15. The locking mechanism for an electromechanical brake according to claim 10, wherein the switching element is weight-optimized with a lowest possible mass and/or with an advantageously balanced distribution of the mass.

16. The locking mechanism for an electromechanical brake according to claim 10, wherein the switching element is configured in one piece monolithically, and is produced by injection molding and/or stamping and/or forming.

17. An electromechanical brake having a function as a parking brake for use in a motor vehicle, the electromechanical brake comprising:
a locking mechanism for locking an actuating direction of an electromechanical brake, the locking mechanism including:
a ratchet wheel and a pawl configured to block a direction of rotation of the ratchet wheel in a locked state of the locking mechanism and to release the rotation of the ratchet wheel in an unlocked state of the locking mechanism,
a switching element which, in a rest state of the switching element, fixes the pawl in the unlocked state of the locking mechanism, and
an actuator including a magnetic coil or a linear drive,
wherein the switching element can be transferred via a rotational and/or a translational displacement from the rest state into a first switching state, in which a movement of the pawlis released, the switching element being functionally arranged between the actuator and the pawl, so that the switching element can be switched via the actuator, and the actuator also acts on the pawl via the switching element.

18. A method for reversibly locking a locking mechanism for an electromechanical brake, which locks an actuating direction of the electromechanical brake, the electromechanical brake for use in a motor vehicle, the method comprising the following steps:
rotationally and/or translationally displacing a switching element against a spring action of a first spring element from a rest state to a first switching state by an action of an actuator;
releasing a pawl by the switching element to produce movability of the pawl; and
displacing the pawl against the spring action of a second spring element to engage a ratchet wheel, and transfer of the locking mechanism from the unlocked to the locked state;
wherein the switching element is displaced by the actuator from the first switching state to a second switching state and in the process acts on the pawl by an actuating arrangement, displacing the pawl from the unlocked to the locked state against a spring action of a second spring element, so that the pawl interacts in a locking manner with the ratchet wheel when the second switching state is reached.
